(19) United States
(12) Patent Application Publication
(10) Pub. No.: US 2024/0261948 A1
(43) Pub. Date: Aug. 8, 2024

(54) Compression tool for piston of automobile brake caliper

(71) Applicant: Chaonan Chen, Hangzhou (CN)

(72) Inventor: Chaonan Chen, Hangzhou (CN)

(21) Appl. No.: 18/640,262

(22) Filed: Apr. 19, 2024

(51) Int. Cl. B25B 27/00; F16D 65/00

(52) U.S. Cl. CPC B25B 27/0035; F16D 65/0043

(57) ABSTRACT

The present disclosure relates to a compression tool for a piston of an automobile brake caliper, and belongs to the technical field of automobile maintenance. The compression tool for the piston of the automobile brake caliper includes: an outer cylinder and an inner cylinder; the inner cylinder is slidably connected to an inner surface of the outer cylinder; an outer surface of the outer cylinder is fixedly connected with a first pressure plate; an outer surface of the inner cylinder is fixedly connected with a second pressure plate arranged outside the outer cylinder; and a user can simultaneously drive the first pressure plate and the second pressure plate to flatly and straightly push a raised piston to be reset through an adjustment mechanism.

### TECHNICAL FIELD

The present disclosure relates to the technical field of automobile maintenance, and in particular, to a compression tool for a piston of an automobile brake caliper.

### BACKGROUND

A brake caliper is a caliper device that has functions of slowing down moving wheels, stopping the moving wheels, or maintaining a stopped state of the moving wheels, and is usually suitable for disc brake systems. The brake caliper is located at a raised position on an outer side of a brake pad. The brake caliper is a part that can improve the braking performance and is also an important part in an automotive brake system. The working principle of the brake caliper is using a hydraulic principle. When a driver steps on a brake pedal, brake oil flows into the brake caliper from a main cylinder to push a piston to move outwards and then push a brake pad to clamp a brake disc, generating a friction force and slowing down or stopping the vehicle.

During replacement of the brake pad for the automobile brake caliper, the old brake pad become thinner, causing the piston of the caliper to be pushed outwards. If the piston is not pressed back, a new brake pad cannot be mounted on the brake disc because the brake pad is too thick. However, in the prior art, the piston of the automobile brake caliper is compressed to its original position through a tool such as a pry bar, which not only easily damages the automobile brake caliper, but also increases the labor intensity of a worker.

### SUMMARY

Based on this, it is necessary to provide a compression tool for a piston of an automobile brake caliper for the problem that the difficulty of replacing a brake pad by a worker is increased because a piston of the existing automobile brake caliper is hard to reset after being pushed out.

A compression tool for a piston of an automobile brake caliper includes an outer cylinder and an inner cylinder, wherein the inner cylinder is slidably connected to an inner surface of the outer cylinder; an outer surface of the outer cylinder is fixedly connected with a first pressure plate; an outer surface of the inner cylinder is fixedly connected with a second pressure plate arranged outside the outer cylinder; an internal thread is arranged on the inner surface of the outer cylinder; and an inner side of the internal thread is in threaded connection with an adjustment mechanism that is in contact with the inner cylinder.

In an embodiment, a user can simultaneously drive the first pressure plate and the second pressure plate to flatly and straightly push a raised piston to be reset through the adjustment mechanism. Compared with an existing method for pushing by using a pry bar, the compression tool effectively avoids a phenomenon that the brake caliper or piston is scratched or pushed to deform by the pry bar, and all raised pistons can be reset in one go, so that the user does not need to adjust the pistons one by one, which also reduces the operation burden of the user.

Further, the adjustment mechanism includes a threaded adjustment rod that is in threaded connection to the inner side of the internal thread; two ends of the threaded adjustment rod penetrate through the outer cylinder; one end of the threaded adjustment rod penetrates through the inner cylinder; and a surface of the threaded adjustment rod is in threaded connection with a locking nut that is in contact with the inner cylinder.

In one embodiment, the user can stably adjust a distance between the first pressure plate and the second pressure plate through the adjustment mechanism to improve the practicality of the compression tool for the piston of the automobile brake caliper.

Further, a threaded hole is formed in the outer surface of the outer cylinder; a rectangular groove communicated to the threaded hole is formed in the outer surface of the inner cylinder; an inner side of the threaded hole is in threaded connection with a positioning bolt; two ends of the positioning bolt penetrate through the threaded hole; and one end of the positioning bolt is inserted into the rectangular groove.

In one embodiment, the positioning bolt cooperates with the rectangular groove, which can prevent the outer cylinder from rotating with the threaded adjustment rod, so that the threaded adjustment rod can only drive the internal thread and the outer cylinder to move through the rotation, so as to ensure that the distance between the first pressure plate and the second pressure plate can be normally extended. This achieves a good limiting effect.

Further, the outer cylinder and the first pressure plate are fixedly connected together through integrated welding, and the inner cylinder and the second pressure plate are fixedly connected together through integrated welding.

In one embodiment, the integrated welding has the advantages of high rigidity and integrity, excellent strength and stiffness, and being more economical than a rolling method or another other connection method.

Further, a size of the first pressure plate and a size of the second pressure plate are the same, and corners of both the first pressure plate and the second pressure plate are rounded.

In one embodiment, this can not only make the first pressure plate and the second pressure plate abut against the piston more flatly and straightly, but also reduce the probability that the first pressure plate and thee second pressure plate scratch the piston or the brake caliper, thereby achieving a good protection effect.

Further, a surface of the threaded adjustment rod is slidably connected with a circular ring gasket; the circular ring gasket is arranged between the locking nut and the inner cylinder; a diameter of the circular ring gasket is greater than an inner diameter of the inner cylinder; and an inner diameter of the circular ring gasket is less than a diameter of the locking nut.

In one embodiment, the circular ring gasket can make the locking nut abut against the inner cylinder more flatly and straightly, so as to reduce the probability that the locking nut gets stuck inside the inner cylinder due to tilting, deviation and other factors, thereby ensuring smooth adjustment of the distance between the first pressure plate and the second pressure plate.

Further, an insertion hole is formed in a surface of the threaded adjustment rod; the adjustment mechanism further includes an auxiliary adjustment assembly that is slidably connected to an inner side of the insertion hole; two ends of the auxiliary adjustment assembly penetrate through the insertion hole;

the auxiliary adjustment assembly includes a force arm lever; the force arm lever is slidably connected to the inner side of the insertion hole; and two ends of the force arm lever penetrate through the insertion hole.

In one embodiment, when the user needs to quickly and easily rotate the threaded adjustment rod, the user only needs to pull one end of the force arm lever away from the insertion hole, so that a force arm between the force arm lever and the threaded adjustment rod is extended. When the force arm lever is moved to a designated position, the user can easily rotate the threaded adjustment rod by driving one end of the force arm lever.

Further, an axial line of the insertion hole is perpendicular to an axial line of the threaded adjustment rod, and the axial line of the insertion hole overlaps an axial line of the force arm lever.

In one embodiment, this can increase an effective creation length of the force arm to ensure that the user can quickly and easily rotate the threaded adjustment rod.

Further, two external threads are formed in a surface of the force arm lever; the two external threads are respectively arranged on two sides of the insertion hole; surfaces of the external threads are in threaded connection with hexagonal nuts; and a diameter of each hexagonal nut is greater than an inner diameter of the insertion hole.

In one embodiment, when the user needs to remove the force arm lever, the user only needs to unscrew one of the hexagonal nuts. At this time, one end of the force arm lever loses its obstruction, and the user can remove the force arm lever.

Further, a length of each external thread is less than a length of each hexagonal nut, and the corners of the hexagonal nuts are rounded.

In one embodiment, this can avoid direct contact between the external threads and the user, thus avoiding the probability that the external threads scratch the user. Meanwhile, the hexagonal nuts with the rounded corners are used, which can further reduce the probability that the hexagonal nuts scratch the user, thereby improving the safety factor of the user during use.

Further, a diameter of a cross section of the positioning bolt arranged in the rectangular groove is the same as a width of the rectangular groove.

In one embodiment, the inner cylinder can prevent the outer cylinder from shaking through the rectangular groove and the positioning bolt, thereby improving the stability when the distance between the first pressure plate and the second pressure plate is extended.

Further, a portion of the positioning bolt arranged outside the outer cylinder is shaped like a regular hexagonal column; and a portion of corners of the positioning bolt arranged outside the outer cylinder is rounded.

In one embodiment, this can facilitate the user to rotate the positioning bolt, thus allowing the user to easily perform an adjustment operation.

1. According to the compression tool for the piston of the automobile brake caliper, a user can simultaneously drive the first pressure plate and the second pressure plate to flatly and straightly push a raised piston to be reset through an adjustment mechanism. Compared with an existing method for pushing by using a pry bar, the compression tool effectively avoids a phenomenon that the brake caliper or piston is scratched or pushed to deform by the pry bar, and all raised pistons can be reset in one go, so that the tool can be used on a caliper with a plurality of pistons, and the user does not need to adjust the pistons one by one, which also reduces the operation burden of the user.

2. The positioning bolt cooperates with the rectangular groove, which can prevent the outer cylinder from rotating with the threaded adjustment rod, so that the threaded adjustment rod can only drive the internal thread and the outer cylinder to move through the rotation, so as to ensure that the distance between the first pressure plate and the second pressure plate can be normally extended. This achieves a good limiting effect.

3. When the user needs to quickly and easily rotate the threaded adjustment rod, the user only needs to pull one end of the force arm lever away from the insertion hole, so that a force arm between the force arm lever and the threaded adjustment rod is extended. When the force arm lever is moved to a designated position, the user can easily rotate the threaded adjustment rod by driving one end of the force arm lever.

### BRIEF DESCRIPTION OF THE DRAWINGS

To describe the technical solutions of the present disclosure or in the prior art more clearly, the following briefly introduces the accompanying drawings for describing the embodiments or the related art. Apparently, the accompanying drawings in the following description show some embodiments of the present disclosure, and a person of ordinary skill in the art may still derive other drawings from the accompanying drawings without creative efforts.

FIG. 1 is a schematic diagram of contact between a compression tool for a piston of an automobile brake caliper and a piston of an automobile brake caliper in the present disclosure;

FIG. 2 is a schematic structural diagram of a compression tool for a piston of an automobile brake caliper in the present disclosure;

FIG. 3 is a schematic cross-sectional diagram of a compression tool for a piston of an automobile brake caliper in the present disclosure;

FIG. 4 is an exploded diagram of a compression tool for a piston of an automobile brake caliper in the present disclosure; and

FIG. 5 is a partially schematic structural diagram of an existing automobile brake caliper with a plurality of pistons.

### REFERENCE NUMERALS IN THE DRAWINGS

100: outer cylinder; 110: internal thread; 120: threaded hole; 200: inner cylinder; 210: rectangular groove; 300: first pressure plate; 400: second pressure plate; 500: adjustment mechanism; 510: threaded adjustment rod; 511: insertion hole; 520: locking nut; 530: circular ring gasket; 540: auxiliary adjustment assembly; 541: force arm lever; 5411: external thread; 542: hexagonal nut; and 600: positioning bolt.

### DETAILED DESCRIPTION OF THE EMBODIMENTS

In order to make the objectives, technical solutions, and advantages of the embodiments of the present disclosure clearer, the technical solutions in the embodiments of the present disclosure are clearly and completely explained below with reference to the accompanying drawings in the embodiments of the present disclosure. Apparently, the described embodiments are merely some rather than all of the embodiments of the present disclosure. All other embodiments obtained by a person of ordinary skill in the art based on the embodiments of present disclosure without making creative efforts shall fall within the protection scope of present disclosure.

It should be noted that when an assembly is referred to as being “fixed” or “arranged” to another assembly, the assembly can be directly on the another assembly or there can be an intermediate assembly. When an assembly is considered to be “connected” to another assembly, the assembly can be directly connected to the another assembly or there may be an intermediate assembly. The terms “vertical”, “horizontal”, “up”, “down”, “left”, “right”, and similar expressions used in this specification of the present disclosure are for illustrative purposes only and do not necessarily represent the only implementation.

In addition, the terms “first” and “second” are used for descriptive purposes only and are not to be construed as indicating or implying relative importance or to implicitly indicate the number of technical features indicated. From this, features defined as “first” and “second” may explicitly or implicitly include at least one feature. In the description of the present disclosure, “plurality” means at least two, for example, two and three, unless explicitly specified otherwise.

In the present disclosure, unless otherwise explicitly stipulated and restricted, that a first feature is “on” or “below” a second feature may include that the first feature is in direct contact with and the second feature, or that the first feature is in indirect contact with the second feature through an intermediate. In addition, that the first feature is “on”, “above”, or “over” the second feature may include that the first feature is directly or diagonally above the second feature or merely indicates that a level of the first feature is higher than that of the second feature. The first feature being “below”, “beneath”, and “under” of the second feature can indicate that the first feature is directly or diagonally below the second feature, or merely indicates that a level of the first feature is less than that of the second feature.

Unless otherwise defined, all technical and scientific terms used in this specification of the present disclosure have the same meaning as those commonly understood by a person skilled in the art to which the present disclosure belongs. The terms used in this specification of the present disclosure are merely intended to describe objectives of the specific implementations, but are not intended to limit the present disclosure. The term “and/or” used in this specification of the present disclosure includes any and all combinations of one or more related listed items.

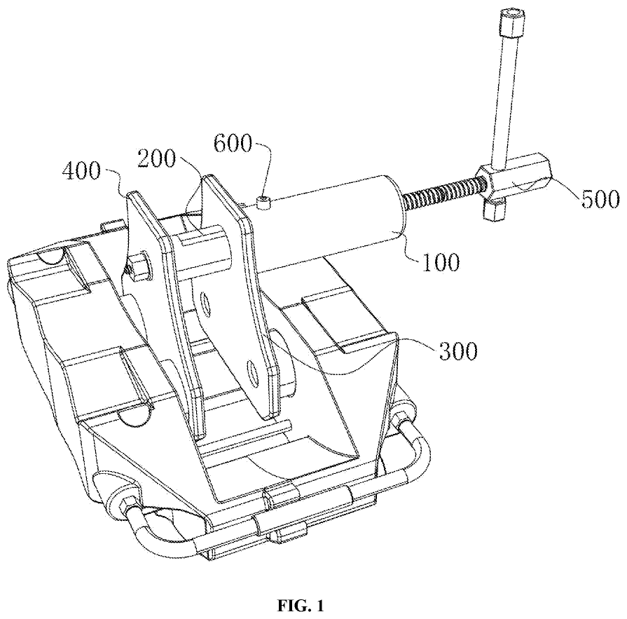

A compression tool for a piston of an automobile brake caliper will be described below in combination with FIG. 1 to FIG. 4.

In an embodiment, the compression tool for the piston of the automobile brake caliper includes an outer cylinder 100 and an inner cylinder 200. The inner cylinder 200 is slidably connected to an inner surface of the outer cylinder 100; an outer surface of the outer cylinder 100 is fixedly connected with a first pressure plate 300; an outer surface of the inner cylinder 200 is fixedly connected with a second pressure plate 400 arranged outside the outer cylinder 100; an internal thread 110 is arranged on the inner surface of the outer cylinder 100; an inner side of the internal thread 110 is in threaded connection with an adjustment mechanism 500 that is in contact with the inner cylinder 200. The outer cylinder 100 and the first pressure plate 300 are fixedly connected together through integrated welding, and the inner cylinder 200 and the second pressure plate 400 are fixedly connected together through integrated welding. The advantages of the integrated welding are as follows: I. Integrity and rigidity: In an integrally welded structure, tight connection between different components is achieved through the welding technology, forming a whole with high rigidity and integrity. This connection method can significantly reduce changes in a gap in mechanical connection and reduce the deformation under an external force, thus improve the stability and reliability of the structure. II. Strength and stiffness: The strength and stiffness of the integrally welded structure can be usually the same as the strength and stiffness of a base material. During the welding, connections between metal atoms make joints have excellent strength and stiffness, which can bear various loads along with a base metal. III. Economy: Compared with other connection methods, the integrated welding is more economical in some cases. Especially when some profiles are used, using a welded structure can be more economical than a rolling method or another connection method. A size of the first pressure plate 300 and a size of the second pressure plate 400 are the same, and corners of both the first pressure plate 300 and the second pressure plate 400 are rounded. Specific shapes of the first pressure plate 300 and the second pressure plate 400 can be correspondingly designed according to a shape of an inside of the brake caliper. The specific shapes are selected according to an actual situation, which will not be elaborated here. This can not only make the first pressure plate 300 and the second pressure plate 400 abut against the piston more flatly and straightly, but also reduce the probability that the first pressure plate 300 and the second pressure plate 400 scratch the piston or the brake caliper, thereby achieving a good protection effect.

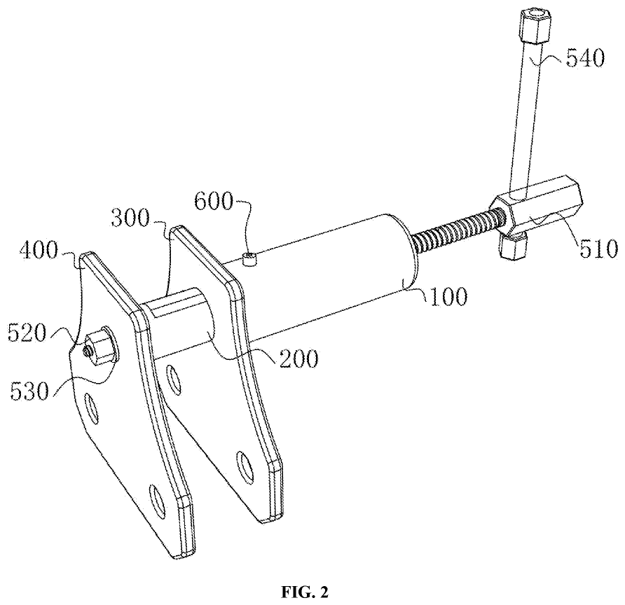

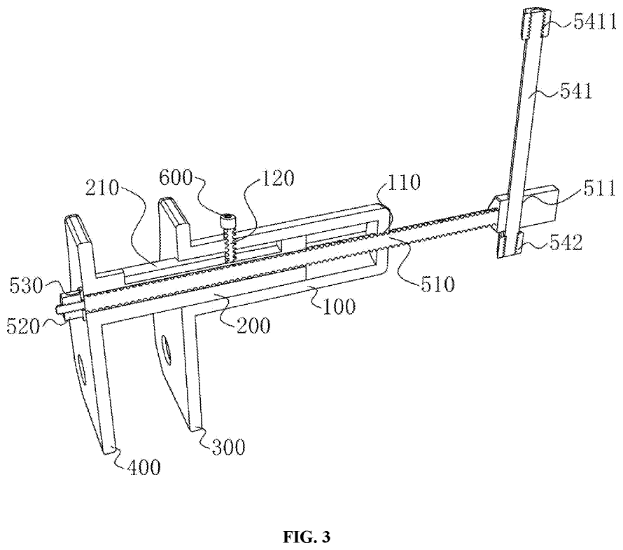

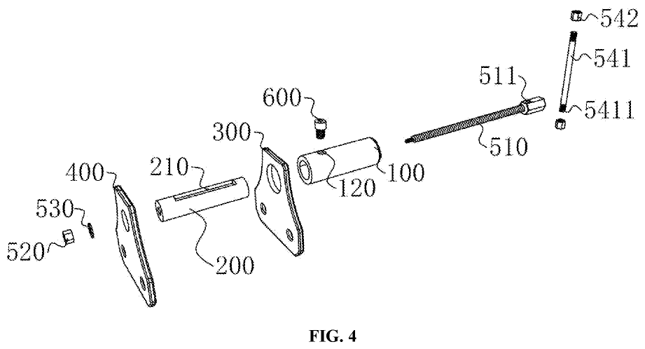

As shown in FIG. 2, FIG. 3, and FIG. 4, the adjustment mechanism 500 includes a threaded adjustment rod 510 that is in threaded connection to the inner side of the internal thread 110; two ends of the threaded adjustment rod 510 penetrate through the outer cylinder 100; one end of the threaded adjustment rod 510 penetrates through the inner cylinder 200; a surface of the threaded adjustment rod 510 is in threaded connection with a locking nut 520 that is in contact with the inner cylinder 200. The other end of the threaded adjustment rod 510 is hexagonal, so that a sleeve and a ratchet wrench can be used. This adds a use method. A surface of the threaded adjustment rod 510 is slidably connected with a circular ring gasket 530; the circular ring gasket 530 is arranged between the locking nut 520 and the inner cylinder 200; a diameter of the circular ring gasket 530 is greater than an inner diameter of the inner cylinder 200; and an inner diameter of the circular ring gasket 530 is less than a diameter of the locking nut 520. The circular ring gasket 530 can make the locking nut 520 abut against the inner cylinder 200 more flatly and straightly, so as to reduce the probability that the locking nut 520 gets stuck inside the inner cylinder 200 due to tilting, deviation and other factors, thereby ensuring smooth adjustment of the distance between the first pressure plate 300 and the second pressure plate 400.

As shown in FIG. 3 and FIG. 4, an insertion hole 511 is formed in a surface of the threaded adjustment rod 510; the adjustment mechanism 500 further includes an auxiliary adjustment assembly 540 that is slidably connected to an inner side of the insertion hole 511; and two ends of the auxiliary adjustment assembly 540 penetrate through the insertion hole 511. The auxiliary adjustment assembly 540 includes a force arm lever 541; the force arm lever 541 is slidably connected to the inner side of the insertion hole 511; and two ends of the force arm lever 541 penetrate through the insertion hole 511. When the user needs to quickly and easily rotate the threaded adjustment rod 510, the user only needs to pull one end of the force arm lever 541 away from the insertion hole 511, so that a force arm between the force arm lever 541 and the threaded adjustment rod 510 is extended. When the force arm lever 541 is moved to a designated position, the user can easily rotate the threaded adjustment rod 510 by driving one end of the force arm lever 541. An axial line of the insertion hole 511 is perpendicular to an axial line of the threaded adjustment rod 510, and the axial line of the insertion hole 511 overlaps an axial line of the force arm lever 541. This can increase an effective creation length of the force arm to ensure that the user can quickly and easily rotate the threaded adjustment rod 510. Two external threads 5411 are formed in a surface of the force arm lever 541; the two external threads 5411 are respectively arranged on two sides of the insertion hole 511; surfaces of the external threads 5411 are in threaded connection with hexagonal nuts 542; and a diameter of each hexagonal nut 542 is greater than an inner diameter of the insertion hole 511. When the user needs to remove the force arm lever 541, the user only needs to unscrew one of the hexagonal nuts 542. At this time, one end of the force arm lever 541 loses its obstruction, and the user can remove the force arm lever 541. A length of each external thread 5411 is less than a length of each hexagonal nut 542, and the corners of the hexagonal nuts 542 are rounded. This can avoid direct contact between the external threads 5411 and the user, thus avoiding the probability that the external threads 5411 scratch the user. Meanwhile, the hexagonal nuts 542 with the rounded corners are used, which can further reduce the probability that the hexagonal nuts 542 scratch the user, thereby improving the safety factor of the user during use.

As shown in FIG. 1, FIG. 2, FIG. 3, and FIG. 4, a threaded hole 120 is formed in the outer surface of the outer cylinder 100; a rectangular groove 210 communicated to the threaded hole 120 is formed in the outer surface of the inner cylinder 200; an inner side of the threaded hole 120 is in threaded connection with a positioning bolt 600; two ends of the positioning bolt 600 penetrate through the threaded hole 120; and one end of the positioning bolt 600 is inserted into the rectangular groove 210. In a process that the threaded adjustment rod 510 drives the outer cylinder 100 to rotate through the internal thread 110, the inner cylinder 200 prevents the outer cylinder 100 from rotating through the rectangular groove 210 and the positioning bolt 600, so that the threaded adjustment rod 510 can only drive the internal thread 110 and the outer cylinder 100 to move through rotation to ensure that the distance between the first pressure plate 300 and the second pressure plate 400 can be normally extended. A diameter of a cross section of the positioning bolt 600 arranged in the rectangular groove 210 is the same as a width of the rectangular groove 210. The inner cylinder 200 can prevent the outer cylinder 100 from shaking through the rectangular groove 210 and the positioning bolt 600, thereby improving the stability when the distance between the first pressure plate 300 and the second pressure plate 400 is extended. Further, a portion of the positioning bolt 600 arranged outside the outer cylinder 100 is shaped like a regular hexagonal column; and a portion of corners of the positioning bolt 600 arranged outside the outer cylinder 100 is rounded. This can facilitate the user to rotate the positioning bolt 600, thus allowing the user to easily perform an adjustment operation.

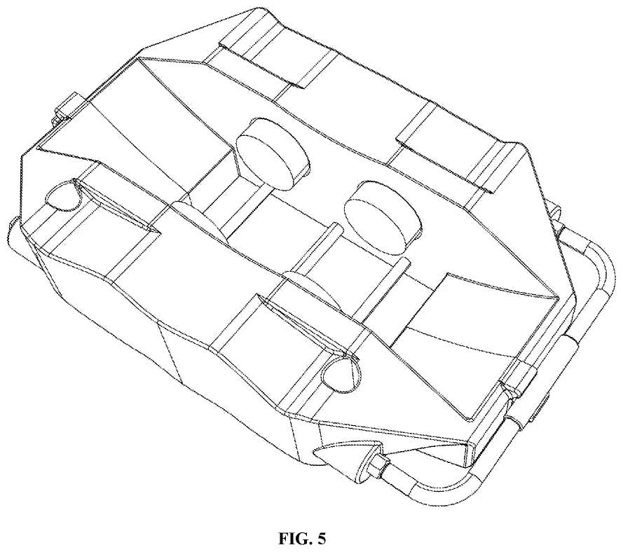

As shown in FIG. 1 and FIG. 5, the compression tool for the piston of the automobile brake caliper is not only applicable to pushing the piston of an automobile brake caliper with a single piston, but also to pushing the pistons of an automobile brake caliper with a plurality of pistons. The user can reset all raised pistons in one go, and does not need to adjust the pistons one by one, thereby reducing the operation burden of the user.

The working principle is as follows: When the user needs to compress the pistons, the user first places both the first pressure plate 300 and the second pressure plate 400 between the pistons on two sides, and then rotates the threaded adjustment rod 510 in a corresponding direction. The threaded adjustment rod 510 drives the outer cylinder 100 to move in a direction away from the second pressure plate 400 through the internal thread 110, and the outer cylinder 100 drives the first pressure plate 300 to move in a direction away from the second pressure plate 400. At this time, the distance between the first pressure plate 300 and the second pressure plate 400 is extended. In this process, the first pressure plate 300 cooperates with the second pressure plate 400 to respectively push the pistons on the two sides until the pistons on the two sides are completely pushed into piston cavities used for placing pistons. In this case, there is no obstruction inside the brake caliper, and the user can normally mount a brake pad. Compared with an existing method for pushing by using a pry bar, the user can simultaneously drive the first pressure plate 300 and the second pressure plate 400 to flatly and straightly push the raised pistons to be reset through the adjustment mechanism 500. This effectively avoids a phenomenon that the brake caliper or piston is scratched or pushed to deform by the pry bar, and all the raised pistons can be reset in one go, so that the user does not need to adjust the pistons one by one, which also reduces the operation burden of the user.

All the technical features of the above embodiments can be combined randomly. For the sake of brevity, all possible combinations of all the technical features in the above embodiments are not described. However, these technical features shall all be considered to fall within the scope of this specification as long as there is no contradiction in their combinations.

The foregoing embodiments merely express several implementations of the present disclosure. The descriptions thereof are relatively specific and detailed, but are not understood as limitations on the scope of the present disclosure. It should be pointed out that a person of ordinary skill in the art can also make several transformations and improvements without departing from the idea of the present disclosure. These transformations and improvements fall within the protection scope of the present disclosure. Therefore, the protection scope of the present disclosure shall be subject to the appended claims.

What is claimed is:

1. A compression tool for a piston of an automobile brake caliper, comprising:
an outer cylinder (100) and an inner cylinder (200), wherein the inner cylinder (200) is slidably connected to an inner surface of the outer cylinder (100); an outer surface of the outer cylinder (100) is fixedly connected with a first pressure plate (300); an outer surface of the inner cylinder (200) is fixedly connected with a second pressure plate (400) arranged outside the outer cylinder (100); an internal thread (110) is arranged on the inner surface of the outer cylinder (100); an inner side of the internal thread (110) is in threaded connection with an adjustment mechanism (500) that is in contact with the inner cylinder (200);
the adjustment mechanism (500) comprises a threaded adjustment rod (510) that is in threaded connection to the inner side of the internal thread (110); two ends of the threaded adjustment rod (510) penetrate through the outer cylinder (100); one end of the threaded adjustment rod (510) penetrates through the inner cylinder (200); a surface of the threaded adjustment rod (510) is in threaded connection with a locking nut (520) that is in contact with the inner cylinder (200);
a threaded hole (120) is formed in the outer surface of the outer cylinder (100); a rectangular groove (210) communicated to the threaded hole (120) is formed in the outer surface of the inner cylinder (200); an inner side of the threaded hole (120) is in threaded connection with a positioning bolt (600); two ends of the positioning bolt (600) penetrate through the threaded hole (120); and one end of the positioning bolt (600) is inserted into the rectangular groove (210).

2. The compression tool for the piston of the automobile brake caliper according to claim 1, wherein the outer cylinder (100) and the first pressure plate (300) are fixedly connected together through integrated welding, and the inner cylinder (200) and the second pressure plate (400) are fixedly connected together through integrated welding.

3. The compression tool for the piston of the automobile brake caliper according to claim 1, wherein a size of the first pressure plate (300) and a size of the second pressure plate (400) are the same, and corners of both the first pressure plate (300) and the second pressure plate (400) are rounded.

4. The compression tool for the piston of the automobile brake caliper according to claim 1, wherein a surface of the threaded adjustment rod (510) is slidably connected with a circular ring gasket (530); the circular ring gasket (530) is arranged between the locking nut (520) and the inner cylinder (200); a diameter of the circular ring gasket (530) is greater than an inner diameter of the inner cylinder (200); and an inner diameter of the circular ring gasket (530) is less than a diameter of the locking nut (520).

5. The compression tool for the piston of the automobile brake caliper according to claim 1, wherein an insertion hole (511) is formed in a surface of the threaded adjustment rod (510); the adjustment mechanism (500) further comprises an auxiliary adjustment assembly (540) that is slidably connected to an inner side of the insertion hole (511); two ends of the auxiliary adjustment assembly (540) penetrate through the insertion hole (511);
the auxiliary adjustment assembly (540) comprises a force arm lever (541); the force arm lever (541) is slidably connected to the inner side of the insertion hole (511); and two ends of the force arm lever (541) penetrate through the insertion hole (511).

6. The compression tool for the piston of the automobile brake caliper according to claim 5, wherein an axial line of the insertion hole (511) is perpendicular to an axial line of the threaded adjustment rod (510), and the axial line of the insertion hole (511) overlaps an axial line of the force arm lever (541).

7. The compression tool for the piston of the automobile brake caliper according to claim 5, wherein two external threads (5411) are formed in a surface of the force arm lever (541); the two external threads (5411) are respectively arranged on two sides of the insertion hole (511); surfaces of the external threads (5411) are in threaded connection with hexagonal nuts (542); and a diameter of each hexagonal nut (542) is greater than an inner diameter of the insertion hole (511).

8. The compression tool for the piston of the automobile brake caliper according to claim 7, wherein a length of each external thread (5411) is less than a length of each hexagonal nut (542), and the corners of the hexagonal nuts (542) are rounded.

9. The compression tool for the piston of the automobile brake caliper according to claim 1, wherein a diameter of a cross section of the positioning bolt (600) arranged in the rectangular groove (210) is the same as a width of the rectangular groove (210).

10. The compression tool for the piston of the automobile brake caliper according to claim 1, wherein a portion of the positioning bolt (600) arranged outside the outer cylinder (100) is shaped like a regular hexagonal column; and a portion of corners of the positioning bolt (600) arranged outside the outer cylinder (100) is rounded.
